(19) United States
(12) Patent Application Publication
(10) Pub. No.: US 2023/0140256 A1
(43) Pub. Date: May 4, 2023

(54) ELECTRIC DEVICE CONFIGURED TO SUPPORT HIGH SPEED INTERFACE FOR EXPANDING NEURAL NETWORK

(71) Applicant: Electronics and Telecommunications Research Institute, Daejeon (KR)

(72) Inventors: Sung Eun KIM, Daejeon (KR); Tae Wook KANG, Daejeon (KR); Hyuk KIM, Daejeon (KR); Young Hwan BAE, Daejeon (KR); Kyung Jin BYUN, Daejeon (KR); Kwang IL OH, Daejeon (KR); Jae-Jin LEE, Daejeon (KR); In San JEON, Daejeon (KR)

(73) Assignee: Electronics and Telecommunications Research Institute, Daejeon (KR)

(21) Appl. No.: 17/965,393

(22) Filed: Oct. 13, 2022

(30) Foreign Application Priority Data
Oct. 29, 2021 (KR) 10-2021-0146574
Feb. 23, 2022 (KR) 10-2022-0023514

(51) Int. Cl. G06N 3/063; G06N 3/04

(52) U.S. Cl. CPC G06N 3/063; G06N 3/049

(57) ABSTRACT

Disclosed is an electronic device that supports a neural network including a neuron array including neurons, a row address encoder that receives spike signals from neurons and outputs request signals in response to the received spike signals, and a row arbiter tree that receives request signals from the row address encoder and outputs response signals in response to the received request signals. The row arbiter tree includes a first arbiter that arbitrates first and second request signals among request signals, a first latch circuit that stores a state of the first arbiter, a second arbiter that arbitrates third and fourth request signals among request signals, a second latch circuit that stores a state of the second arbiter, and a third arbiter that delivers a response signal to the first and second arbiters based on information stored in the first and second latch circuits.

### CROSS-REFERENCE TO RELATED APPLICATIONS

This application claims priority under 35 U.S.C. § 119 to Korean Patent Application No. 10-2021-0146574 filed on Oct. 29, 2021 and Korean Patent Application No. 10-2022-0023514 filed on Feb. 23, 2022, in the Korean Intellectual Property Office, the disclosures of which are incorporated by reference herein in their entireties.

### BACKGROUND

Embodiments of the present disclosure described herein relate to a neural network, and more particularly, relate to an electronic device configured to support a high-speed interface for expanding a neural network.

There is a growing interest in an artificial intelligence technology that processes information by applying a human thinking process, a human inferring process, and a human learning process to an electronic device. For example, research on signal processing between neurons or synapses, which mimics a human brain, is being conducted. A spike-based neural network was developed based on learning and inference based on input spikes.

However, many neurons are required to imitate human high intelligence. In integrating a plurality of neurons in one semiconductor chip, there are limitations due to area, power consumption, or process issues.

### SUMMARY

Embodiments of the present disclosure provide an electronic device configured to support a high-speed interface for expanding a neural network with improved reliability and improved performance.

According to an embodiment, an electronic device that supports a neural network includes a neuron array including a plurality of neurons, a row address encoder that receives a plurality of spike signals from the plurality of neurons and outputs a plurality of request signals in response to the received plurality of spike signals, and a row arbiter tree that receives the plurality of request signals from the row address encoder and outputs a plurality of response signals in response to the received plurality of request signals. The row arbiter tree includes a first arbiter that arbitrates a first request signal and a second request signal among the plurality of request signals, a first latch circuit that stores a state of the first arbiter, a second arbiter that arbitrates a third request signal and a fourth request signal among the plurality of request signals, a second latch circuit that stores a state of the second arbiter, and a third arbiter that delivers a response signal to the first arbiter and the second arbiter based on information stored in the first latch circuit and the second latch circuit.

In an embodiment, the row address encoder generates the first request signal in response to a spike signal, which is received from neurons located in a first row among the plurality of neurons, from among the plurality of spike signals, generates the second request signal in response to a spike signal, which is received from neurons located in a second row among the plurality of neurons, from among the plurality of spike signals, generates the third request signal in response to a spike signal, which is received from neurons located in a third row among the plurality of neurons, from among the plurality of spike signals, and generates the fourth request signal in response to a spike signal, which is received from neurons located in a fourth row among the plurality of neurons, from among the plurality of spike signals.

In an embodiment, the row address encoder outputs a row signal indicating information about a row of neurons, which correspond to the plurality of response signals, from among the plurality of neurons in response to the plurality of response signals.

In an embodiment, the first arbiter receives the first request signal among the first request signal and the second request signal and receives one of the first request signal and the second request signal before outputting a first response signal to the first request signal among the plurality of response signals. The second arbiter receives the third request signal among the third request signal and the fourth request signal and receives one of the third request signal and the fourth request signal before outputting a third response signal corresponding to the third request signal among the plurality of response signals.

In an embodiment, the electronic circuit further includes a third latch circuit that stores a state of the third arbiter.

In an embodiment, the row address encoder sequentially outputs the plurality of spike signals received from the plurality of neurons as a row signal in response to the plurality of response signals.

In an embodiment, the electronic device further includes a column address encoder that receives the plurality of spike signals from the plurality of neurons and to output a plurality of request signals in response to the received plurality of spike signals and a column arbiter tree that receives the plurality of request signals from the column address encoder and to output a plurality of response signals in response to the received plurality of request signals from the column address encoder.

In an embodiment, the column address encoder outputs a column signal indicating information about neurons, which correspond to the plurality of response signals, from among the plurality of neurons in response to the plurality of response signals received from the column arbiter tree.

According to an embodiment, an electronic device that supports a neural network includes a neuron array including a plurality of neurons and an interface circuit that transmits a plurality of spike signals generated from the plurality of neurons to an external device in parallel. The interface circuit includes a row arbiter tree that arbitrates a plurality of request signals corresponding to the plurality of spike signals. The row arbiter tree includes a first arbiter that returns a first token in response to a first request signal and a second request signal among the plurality of request signals and a second arbiter that returns a second token in response to a third request signal and a fourth request signal among the plurality of request signals. A spike signal corresponding to a request signal obtained by returning the first token among the first request signal and the second request signal is transmitted to the external device through a first path. A spike signal corresponding to a request signal obtained by returning the second token among the third request signal and the fourth request signal is transmitted to the external device through a second path implemented in parallel with the first path.

In an embodiment, the interface circuit further includes a row address encoder that transmits the plurality of spike signals to the external device in parallel through the first path and the second path based on arbitration of the row arbiter tree.

In an embodiment, the row arbiter tree includes a first latch circuit that stores a state of the first arbiter and a second latch circuit that stores a state of the second arbiter.

In an embodiment, the row address encoder further identifies a return order of the first token and the second token based on information stored in the first latch circuit and the second latch circuit.

### BRIEF DESCRIPTION OF THE FIGURES

The above and other objects and features of the present disclosure will become apparent by describing in detail embodiments thereof with reference to the accompanying drawings.

FIG. 1 is a diagram for describing an operation of a neural network, according to an embodiment of the present disclosure.

FIG. 2 is a block diagram illustrating an electronic device based on an AER protocol implementing the neural network of FIG. 1.

FIG. 3 is a block diagram illustrating a structure of the row arbiter tree of FIG. 2.

FIG. 4 is a block diagram illustrating a structure of the row arbiter tree of FIG. 2.

FIG. 5 is a diagram for describing a multi-token and a multi-path used in the row arbiter tree of FIG. 3.

FIG. 6 is a block diagram illustrating a structure of a row arbiter tree by using the multi-token and multi-path of FIG. 5.

FIG. 7 is a block diagram illustrating an electronic device, according to an embodiment of the present disclosure.

### DETAILED DESCRIPTION

Hereinafter, embodiments of the present disclosure will be described in detail and clearly to such an extent that an ordinary one in the art easily implements the present disclosure.

Hereinafter, the best embodiment of the present disclosure will be described in detail with reference to accompanying drawings. With regard to the description of the present disclosure, to make the overall understanding easy, similar components will be marked by similar reference signs/numerals in drawings, and thus, additional description will be omitted to avoid redundancy.

In the following drawings or in the detailed description, modules may be connected with any other components except for components illustrated in a drawing or described in the detailed description. Modules or components may be connected directly or indirectly. Modules or components may be connected through communication or may be physically connected.

Components that are described in the detailed description with reference to the terms “unit”, “module”, “layer”, etc. will be implemented with software, hardware, or a combination thereof. For example, the software may be a machine code, firmware, an embedded code, and application software. For example, the hardware may include an electrical circuit, an electronic circuit, a processor, a computer, integrated circuit cores, a pressure sensor, a microelectromechanical system (MEMS), a passive element, or a combination thereof

According to an embodiment of the present disclosure, an electronic device configured to drive a spike-based neural network may include a plurality of neurons. Each of a plurality of neurons may generate a spike signal, and the generated spike signals may be transmitted to the outside. In this case, the electronic device according to an embodiment of the present disclosure may prevent a decrease in the transmission speed of a plurality of spike signals generated from a plurality of neurons. For example, the neural network may include a plurality of neurons connected in parallel in a complex structure. Accordingly, a plurality of spike signals generated by a plurality of neurons may also be continuously generated in parallel. In a conventional neural network-based electronic device, a plurality of spike signals are serialized by using an address-event-representative (AER) circuit, and the serialized signals are transmitted to the outside. In this case, a plurality of spike signals generated in a parallel form are converted into a serial form, thereby causing a decrease in transmission speed. On the other hand, the electronic device according to an embodiment of the present disclosure may provide a high-speed AER interface scheme for expanding neurons between neural networks while minimizing distortion related to transmission of a plurality of spikes.

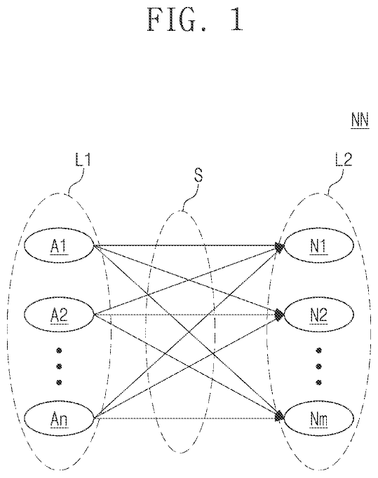

FIG. 1 is a diagram for describing an operation of a neural network, according to an embodiment of the present disclosure. Referring to FIG. 1, a neural network NN may include a first layer L1, a second layer L2, and synapses S. In an embodiment, the neural network NN may be a spiking neural network based on a spike signal. However, the scope of the present disclosure is not limited thereto, and the neural network NN may be configured to support various neural networks or machine learning.

The first layer L1 may include a plurality of axons A1 to An, and the second layer L2 may include a plurality of neurons N1 to Nm. The synapses S may be configured to connect the plurality of axons A1 to An and the plurality of neurons N1 to Nm. Here, each of ‘m’ and ‘n’ may be an arbitrary natural number, and ‘m’ and ‘n’ may be numbers the same as or different from each other.

Each of the axons A1 to An included in the first layer L1 may output a spike signal. The synapses ‘5’ may deliver a spike signal having a weighted synaptic weight to the neurons N1 to Nm included in the second layer L2 based on the output spike signal. Even though a spike signal is output from one axon, spike signals that are delivered from the synapses ‘5’ to the neurons N1 to Nm may vary with synaptic weights, each of which is the connection strength of each of the synapses ‘5’. For example, when a synaptic weight of a first synapse is greater than a synaptic weight of a second synapse, a neuron connected with the first synapse may receive a spike signal of a greater value than a neuron connected with the second synapse.

Each of the neurons N1 to Nm included in the second layer L2 may receive the spike signal delivered from the synapses ‘5’. Each of the neurons N1 to Nm that has received the spike signal may output a neuron spike based on the received spike signal. For example, when the accumulated value of the spike signal received in the second neuron N2 becomes greater than a threshold, the second neuron N2 may output a neuron spike.

For example, as illustrated in FIG. 1, when a second axon A2 outputs spike signals, the synapses ‘5’ connected to the second axon A2 may deliver the spike signals to the neurons N1 to Nm. The delivered spike signals may vary with synaptic weights of the synapses “S” connected with the second axon A2. A spike signal may be delivered to the second neuron N2 from a synapse connecting the second axon A2 and the second neuron N2. When a value of the accumulated spike signal of the second neuron N2 becomes greater than the threshold by the delivered spike signal, the second neuron N2 may output a neuron spike.

As illustrated in FIG. 1, in embodiments of the present disclosure, a layer where the axons A1 to An are included may be a layer prior to a layer where the neurons N1 to Nm are included. Also, the layer including the neurons N1 to Nm may be a layer following a layer including the axons A1 to An. Accordingly, the spike signals may be delivered to the neurons N1 to Nm in the next layer depending on synaptic weights weighted in spike signals output from the axons A1 to An, and the neurons N1 to Nm may output neuron spikes based on the delivered spike signals.

Although not shown in FIG. 1, spike signals may be delivered to neurons of the next layer depending on outputs of the neuron spikes in the second layer L2. For example, when spike signals are delivered from the second layer L2 to the third layer, axons of the second layer L2 may output the spike signals depending on the outputs of the neuron spikes, and spike signals, to which synaptic weights are weighted, may be delivered to neurons of a third layer based on the output spike signals. When an accumulation value of the delivered spike signal is greater than a threshold, neurons of the third layer may output neuron spikes. That is, one layer may include both axons and neurons, or either axons or neurons.

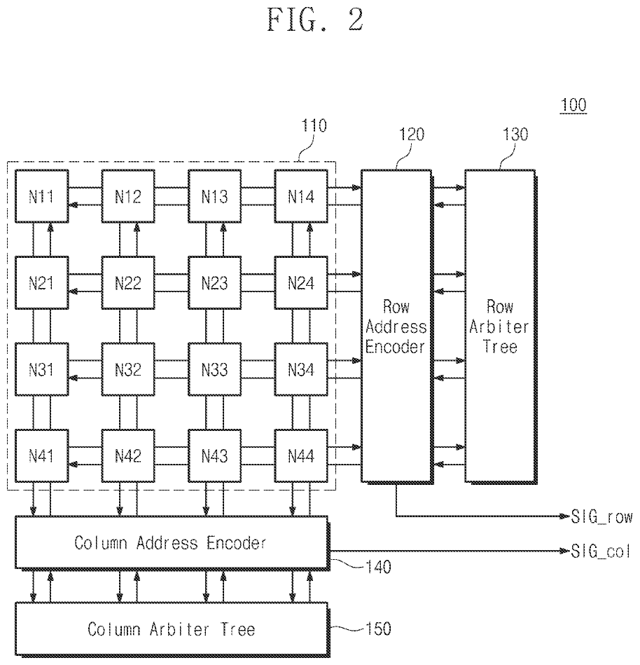

FIG. 2 is a block diagram illustrating an electronic device based on an AER protocol implementing the neural network of FIG. 1. Referring to FIGS. 1 and 2, an electronic device 100 may include a neuron array 110, a row address encoder 120, a row arbiter tree 130, a column address encoder 140, and a column arbiter tree 150.

In an embodiment, the electronic device 100 of FIG. 2 may be configured to support an AER protocol-based communication structure. The AER protocol is a point-to-point protocol capable of asynchronously delivering spike information of a neuron, at which a spike has fired, to another neuron. A synapse connection of by the synapses S of FIG. 1 may be implemented by delivering information about a spike fired at one neuron to another neuron.

The delivered information may include information about a timing, at which a spike has fired, and an address of a neuron at which the spike has fired.

In an embodiment, in the electronic device 100 of FIG. 2, components (e.g., the row address encoder 120, the row arbiter tree 130, the column address encoder 140, and the column arbiter tree 150) other than the neuron array 110 may indicate an interface circuit or AER interface circuit, which is configured to transmit spike signals generated from the neuron array 110 to the outside of the electronic device 100 or to another electronic device.

The neuron array 110 may include the plurality of neurons N11 to N44. To improve the degree of integration of the electronic device 100, the plurality of neurons N11 to N44 may be arranged in a row direction and a column direction. For brevity of illustration, it is illustrated that the plurality of neurons N11 to N44 of FIG. 2 are arranged in four rows and four columns, but the scope of the present disclosure is not limited thereto. The number of neurons included in the neuron array 110, the number of rows, in each of which neurons are arranged, and the number of columns, in each of which neurons are arranged may be increased or decreased. In an embodiment, the neuron array 110 may have arrangements having various types, each of which is different from a type of the arrangement shown in FIG. 2.

Each of the plurality of neurons N11 to N44 included in the neuron array 110 may be a neuron (e.g., one of N1 to Nm) of FIG. 1 or one of the axons A1 to An of FIG. 1, and may output a spike signal. A process of outputting a spike signal may be implemented by outputting the address of a neuron block where a spike has fired. The output address may include an address for a row and an address for a column. In an embodiment, the address for a row may be sequentially processed in preference to the address for a column. Alternatively, the address for a column may be sequentially processed in preference to the address for a row. Alternatively, the address for a row and the address for a column may be processed simultaneously or in parallel.

For example, the plurality of neurons N11 to N44 included in the neuron array 110 may output spike signals. The spike signal output from the plurality of neurons N11 to N44 may be provided to the row address encoder 120 and the column address encoder 140. The row address encoder 120 may output a row signal SIG row by sequentially processing spike signals output from the plurality of neurons N11 to N44 by using the row arbiter tree 130. The column address encoder 140 may output a column signal SIG col by sequentially processing spike signals output from the plurality of neurons N11 to N44 by using the column arbiter tree 150.

For example, the row address encoder 120 may output a first request signal in response to a spike signal fired from neurons (e.g., N11, N12, N13, and N14) located in the first row among the plurality of neurons N11 to N44, may output a second request signal in response to a spike signal fired from neurons (e.g., N21, N22, N23, and N24) located in the second row among the plurality of neurons N11 to N44, may output a third request signal in response to a spike signal fired from neurons (e.g., N31, N32, N33, and N34) located in a third row among the plurality of neurons N11 to N44, and may output a fourth request signal in response to a spike signal fired from neurons (e.g., N41, N42, N43, N44) located in a fourth row among the plurality of neurons N11 to N44. The row address encoder 120 may provide the generated request signal to the row arbiter tree 130, and the row arbiter tree 130 may provide a response signal corresponding to the request signal to the row address encoder 120 in response to the request signal. The row address encoder 120 may output a row signal SIG_row based on information about the row of neurons corresponding to the received request signal.

Similarly, the column address encoder 140 may output a first request signal in response to a spike signal fired from neurons (e.g., N11, N21, N31, and N41) located in the first column among the plurality of neurons N11 to N44, may output a second request signal in response to a spike signal fired from neurons (e.g., N12, N22, N32, and N42) located in the second column among the plurality of neurons N11 to N44, may output a third request signal in response to a spike signal fired from neurons (e.g., N13, N23, N33, and N43) located in a third column among the plurality of neurons N11 to N44, and may output a fourth request signal in response to a spike signal fired from neurons (e.g., N14, N24, N34, and N44) located in a fourth column among the plurality of neurons N11 to N44. The column address encoder 140 may provide the generated request signal to the column arbiter tree 150, and the column arbiter tree 150 may provide a response signal corresponding to the request signal to the column address encoder 140 in response to the request signal. The column address encoder 140 may output the column signal SIG col based on information about the column of neurons corresponding to the received request signal.

In an embodiment, a neuron, to which a spike signal is output, or a location of the neuron may be determined based on the row signal SIG row and the column signal SIG_col, and a spike signal, to which a weight is reflected, may be provided to another neuron through the synapse ‘S’ corresponding to the determined neuron and the location of the neuron (e.g., other neurons included in the electronic device 100 or neurons included in another electronic device).

In an embodiment, the row arbiter tree 130 may arbitrate spike signals such that the row signal SIG row is output depending on the output order of the spike signals provided from the row address encoder 120. The column arbiter tree 150 may arbitrate spike signals such that the column signal SIG col is output depending on the output order of the spike signals provided from the column address encoder 140. Hereinafter, to describe an embodiment of the present disclosure briefly, a structure of the row arbiter tree 130 will be mainly described. In an embodiment, a structure of the row arbiter tree 130 may be similar to a structure of the column arbiter tree 150.

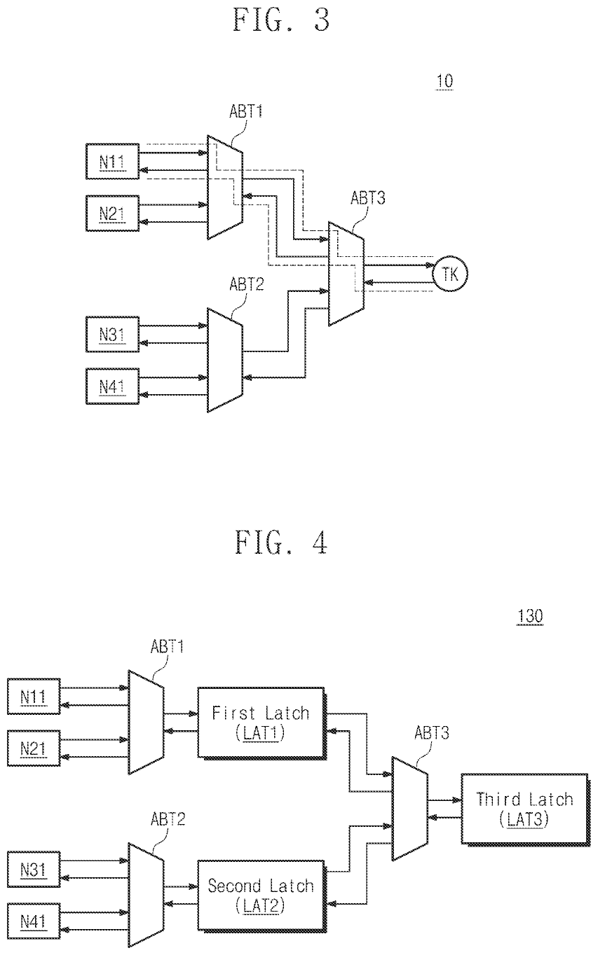

FIG. 3 is a block diagram illustrating a structure of the row arbiter tree of FIG. 2. For brevity of drawing and convenience of description, a component (e.g., a row address encoder) unnecessary to describe the row arbiter tree are omitted, and it is assumed that the row arbiter tree directly receives a request for an output of a spike signal from the neurons N11 to N41 and directly provides a response to the request. However, the scope of the present disclosure is not limited thereto. Spike signals output from the neurons N11 to N41 may be provided to the row address encoder 120, and the row address encoder 120 may provide a request for outputting spike signals to the row arbiter tree, and may receive a response from the row arbiter tree.

The row arbiter tree 10 may be implemented to receive requests from first to fourth neurons N11, N21, N31, and N41 and to output a corresponding response depending on a reception order or a firing order of spike signals.

For example, the row arbiter tree 10 may include first to third arbiters ABT1 to ABT3. The first arbiter ABT1 may be connected to the first and second neurons N11 and N21; the second arbiter ABT2 may be connected to the third and fourth neurons N31 and N41; and, the third arbiter ABT3 may be connected to the first and second arbiters ABT1 and ABT2.

Each of the first to third arbiters ABT1, ABT2, and ABT3 may be configured to arbitrate an operation priority for a corresponding component depending on the reception order of received signals or the occurrence of the received signals. For example, the first arbiter ABT1 may receive response signals from the first and second neurons N11 and N21. The first arbiter ABT1 may be configured to provide an operation priority for a neuron, which first fires, from among the first and second neurons N11 and N21. The second arbiter ABT2 may be configured to provide an operation priority for a neuron, which first fires, from among the third and fourth neurons N31 and N41. The third arbiter ABT3 may be configured to provide an operation priority for an arbiter, which first outputs a spike signal, from among the first and second arbiters ABT1 and ABT2.

That is, an operation priority (e.g., an output order of spike signals fired from the first to fourth neurons N11 to N41) for the first to fourth neurons N11 to N41 may be arbitrated by connecting the first to third arbiters ABT1, ABT2, and ABT3 in a tree structure.

As a more detailed example, it is assumed that the first neuron N11 first fires from among the first to fourth neurons N11 to N41. In this case, a request signal corresponding to the first neuron N11 may be provided to the first arbiter ABT1. In response to a request signal corresponding to the first neuron N11, the first arbiter ABT1 may store information (hereinafter, for convenience of description, it is referred to as a “location of the first neuron N11”.) indicating that the first neuron N11 has fired a spike signal, and may output the request signal. In an embodiment, a configuration in which the first arbiter ABT1 stores information about a location of the first neuron N11 may be implemented by maintaining a path, through which the first arbiter ABT1 receives a response signal and delivers the response signal, so as to correspond to the first neuron N11.

The request signal output from the first arbiter ABT1 is provided to the third arbiter ABT3. The third arbiter ABT3 may return a token TK in response to the request signal received from the first arbiter ABT1. For example, the returning of the token TK may be implemented when the third arbiter ABT3 transmits a response signal including information about the token TK to the first arbiter ABT1. The first arbiter ABT1 may provide the received response signal to the first neuron N11 in response to the response signal received from the third arbiter ABT3. The first neuron N11 may provide the fired spike signal to the outside or another neuron in response to a response signal received from the first arbiter ABT1. Alternatively, the row address encoder 120 may output the corresponding row signal SIG_row in response to the response signal.

As described above, the row arbiter tree 10 may arbitrate an operation priority (e.g., an output order of spike signals fired from the first to fourth neurons N11 to N41) for the first to fourth neurons N11 to N41. However, when the number of neurons corresponding to the row arbiter tree 10 increases (i.e., when the number of request signals input to the row arbiter tree 10 increases), the number of arbiters included in the row arbiter tree 10, and the number of arbiter stages included in the row arbiter tree 10 may increase. In this case, a time in which a response signal (or token) to one request signal is returned may increase. Also, until a response signal (or token) for one request signal is returned, specific neurons needs to wait in a specific state (e.g., a reset state), and request signals corresponding to other neurons may not be provided to the row arbiter tree 10.

That is, according to the structure of the row arbiter tree 10 of FIG. 3, a request signal for other neurons may not be processed until a response signal corresponding to one request signal is returned. Accordingly, the overall signal processing time increases. Also, when a spike signal fires at other neurons while the request signal for a specific neuron is being processed, the firing order of other neurons may not be maintained, and thus signal processing may be distorted.

FIG. 4 is a block diagram illustrating a structure of the row arbiter tree of FIG. 2. Referring to FIGS. 2 and 4, the row arbiter tree 130 may include first to third arbiters ABT1, ABT2, and ABT3, and first to third latches LAT1, LAT2, and LAT3.

For brevity of drawing and convenience of description, a component (e.g., a row address encoder) unnecessary to describe the row arbiter tree are omitted, and it is assumed that the row arbiter tree directly receives a request for an output of a spike signal from the neurons N11 to N41 and directly provides a response to the request. However, the scope of the present disclosure is not limited thereto. Spike signals output from the neurons N11 to N41 may be provided to the row address encoder 120, and the row address encoder 120 may provide a request for outputting spike signals to the row arbiter tree, and may receive a response from the row arbiter tree.

The row arbiter tree 10 may be implemented to receive requests from first to fourth neurons N11, N21, N31, and N41 and to output a corresponding response depending on a reception order or a firing order of spike signals.

For example, the row arbiter tree 10 may include first to third arbiters ABT1 to ABT3. The first arbiter ABT1 may be connected to the first and second neurons N11 and N21, and the second arbiter ABT2 may be connected to the third and fourth neurons N31 and N41.

In an embodiment, unlike the row arbiter tree 10 of FIG. 3, in the row arbiter tree 130 of FIG. 4, the first arbiter ABT1 may exchange a request signal and a response signal with the first latch LAT1, and the second arbiter ABT2 may exchange a request signal and a response signal with the second latch LAT2. The third arbiter ABT3 may be connected to the first and second latches LAT1 and LAT2, and may exchange a request signal and a response signal with the third latch LAT3. That is, in a tree structure of the arbiters ABT1, ABT2, and ABT3 included in the row arbiter tree 130 of FIG. 4, the first to third latches LAT1, LAT2, and LAT3 may be added.

The first to third latches LAT1, LAT2, and LAT3 may be configured to store states of the first to third arbiters ABT1, ABT2, and ABT3. For example, the first latch LAT1 may be configured to store a state of the first arbiter ABT1; the second latch LAT2 may be configured to store a state of the second arbiter ABT2; and, the third latch LAT3 may be configured to store a state of the third arbiter ABT3. In this case, unlike the row arbiter tree 10 of FIG. 3, in the row arbiter tree 130 of FIG. 4, each of the first to third arbiters ABT1, ABT2, and ABT3 does not need to store its own state (i.e., a location of a neuron receiving a request signal). Before a response signal is received at a later stage, each of the first to third arbiters ABT1, ABT2, and ABT3 may receive a response signal for another neuron.

As a more detailed example, it is assumed that the spike signal fires in the first neuron N11. In this case, a request signal corresponding to the first neuron N11 may be delivered to the first arbiter ABT1. The first arbiter ABT1 may store information about a location of the first neuron N11 in the first latch LAT1 in response to the request signal corresponding to the first neuron N11. Afterward, the first arbiter ABT1 is switched to a state capable of receiving a request signal corresponding to the second neuron N21. In other words, the first arbiter ABT1 may receive a request signal corresponding to the second neuron N21 without receiving or outputting a response signal to the request signal corresponding to the first neuron N11, by storing a current state (i.e., information about the location of the first neuron N11) in the first latch LAT1.

A request signal may be provided to the third arbiter ABT3 based on the information stored in the first latch LAT1. The third arbiter ABT3 may store the state of the third arbiter ABT3 in the third latch LAT3 in response to the request signal provided from the first latch LAT1. In an embodiment, when the third arbiter ABT3 is the final stage, the third arbiter ABT3 may provide a response signal to the first latch LAT1 in response to the request signal. In response to the response signal received from the third arbiter ABT3, the first latch LAT1 may provide a response signal to the first neuron N11 based on the stored status information of the first arbiter ABT1.

As mentioned above, when the first latch LAT1 is configured to store the state of the first arbiter ABT1, the second latch LAT2 is configured to store the state of the second arbiter ABT2, and the third latch LAT3 is configured to store the state of the third arbiter ABT3, each of the first to third arbiters ABT1, ABT2, and ABT3 may determine only the order of request signals thus entered. Before receiving an additional response signal, each of the first to third arbiters ABT1, ABT2, and ABT3 may receive request signals from different neurons, respectively. In addition, the plurality of neurons N11, N21, N31, and N41 do not need to wait in a reset state until receiving a response signal from the row arbiter tree 130. That is, through the structure of the row arbiter tree 130 of FIG. 4, parallel processing may be performed on spike signals fired from the plurality of neurons N11, N21, N31, and N41. The firing order of the spike signals fired from a plurality of neurons N11, N21, N31, and N41 may be identified normally.

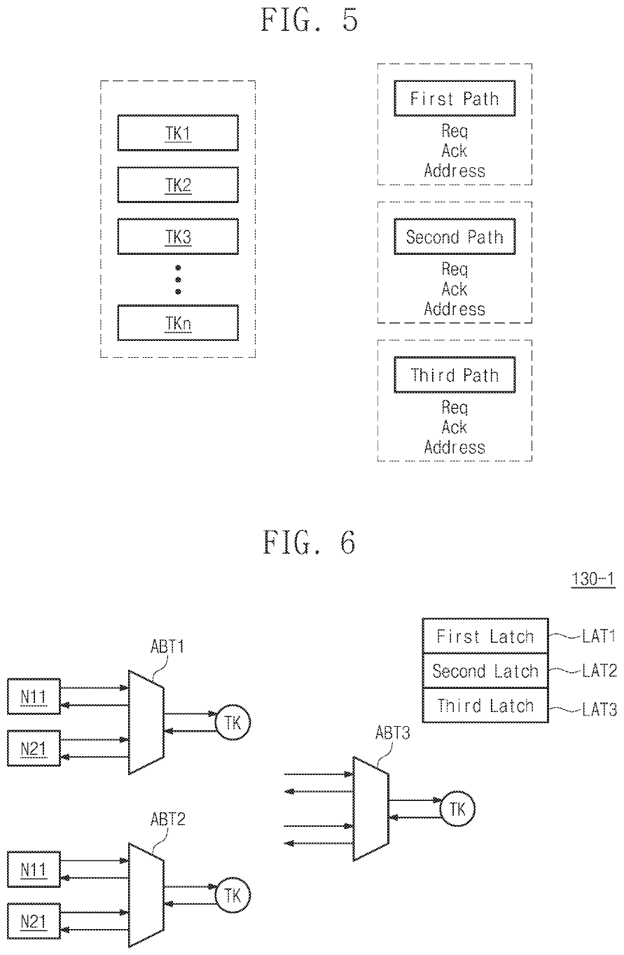

FIG. 5 is a diagram for describing a multi-token and a multi-path used in the row arbiter tree of FIG. 3. FIG. 6 is a block diagram illustrating a structure of a row arbiter tree by using the multi-token and multi-path of FIG. 5.

Referring to FIGS. 2, 4, 5, and 6, a row arbiter tree 130-1 may arbitrate operations of the plurality of neurons N11 to N41 by using a multi-token and a multi-path.

For example, the row arbiter tree 10 described with reference to FIG. 3 arbitrates operations of the plurality of neurons N11 to N41 by using the one token TK. In this case, a neuron, which first fires, from among the neurons N11 to N41 uses the entire structure of the row arbiter tree 10 (e.g., a winner takes all).

On the other hand, as illustrated in FIGS. 5 and 6, when using a multi-token and multi-path, the row arbiter tree 130-1 may arbitrate not only an operation of a neuron, which first fires, but also operations of neurons fired at a later time point, simultaneously or in parallel.

For example, as shown in FIG. 6, the row arbiter tree 130-1 may include the first to third arbiters ABT1, ABT2, and ABT3 and the first to third latches LAT1, LAT2, and LAT3. The first arbiter ABT1 may be configured to arbitrate spike signals fired from the first and second neurons N11 and N21. The second arbiter ABT2 may be configured to arbitrate spike signals fired from the third and fourth neurons N31 and N41. The third arbiter ABT3 may be configured to arbitrate outputs from the first and second arbiters ABT1 and ABT2.

Unlike the structure of the row arbiter tree 10 of FIG. 2, in the row arbiter tree 130-1 of FIG. 6, the token TK may return to each of the first to third arbiters ABT1, ABT2, and ABT3. For example, the first arbiter ABT1 may directly return the token TK in response to a request signal for the first and second neurons N11 and N21. In this case, without receiving a response signal from the next stage (e.g., the third arbiter ABT3), the first arbiter ABT1 may receive request signals for other neurons. In an embodiment, a state (or a calculation result) of the first arbiter ABT1 may be stored in the plurality of latch circuits LAT1 to LAT3. The state of the first arbiter ABT1 stored in the plurality of latch circuits LAT1 to LAT3 may be delivered to the next stage (e.g., the third arbiter ABT3). The next stage (e.g., the third arbiter ABT3) may return the token TK based on information stored in the plurality of latch circuits LAT1 to LAT3. That is, the row arbiter tree 130-1 may use the plurality of tokens TK1 to TKn (or individual tokens) for the plurality of arbiters ABT1 to ABT3, thereby processing a plurality of request signals in the row arbiter tree 130-1, simultaneously or in parallel. In addition, the return order of the plurality of tokens TK1 to TKn may be determined or identified based on the information stored in the latch circuits LAT1 to LAT3. In an embodiment, the row address encoder 120 may identify the return order (i.e., the order of occurrence or transmission of corresponding spike signals) of the tokens TK1 to TKn based on information stored in the latch circuits LAT1 to LAT3.

In an embodiment, the row arbiter tree 130-1 using the tokens TK1 to TKn described above may manage a plurality of paths (e.g., a first path, a second path, and a third path). In an embodiment, each of the paths (e.g., the first path, the second path, and the third path) may mean a path through which a request signal Req, a response signal Ack, and an address Address (e.g., an address corresponding to a location of the corresponding neuron) are transmitted and received.

The plurality of paths (e.g., the first path, the second path, and the third path) may correspond to the plurality of tokens TK1 to TKn. The spike signal emitted from the plurality of neurons N11 to N41 may be delivered to the outside through the paths (e.g., the first path, the second path, and the third path) based on status information stored in the plurality of latches LAT1 to LAT3 depending on the firing order of spike signals of the plurality of neurons N11 to N41. That is, the electronic device 100 according to an embodiment of the present disclosure may transmit and receive spike signals through a plurality of paths, not one transmission path, thereby improving the transmission speed of the spike signal.

In an embodiment, although not shown in drawings, the number of tokens may be the same as the number of paths. Alternatively, the number of tokens may be greater than the number of paths. In this case, each of the paths may be configured to output a spike signal corresponding to at least one or more tokens.

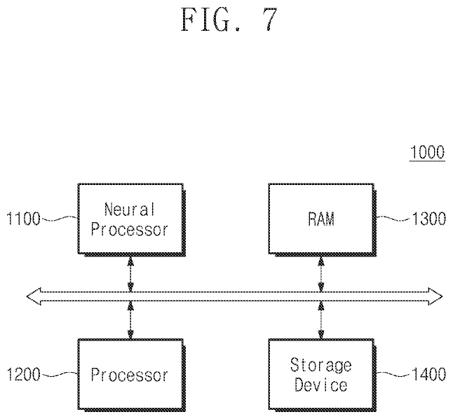

FIG. 7 is a block diagram illustrating an electronic device, according to an embodiment of the present disclosure. Referring to FIG. 7, an electronic device 1000 may include a neural processor 1100, a processor 1200, a random access memory (RAM) 1300, and a storage device 1400. Under the control of the processor 1200, the neural processor 1100 may perform an inference or prediction operation based on various neural network algorithms. For example, the neural processor 1100 may include an operator or an accelerator for processing operations based on a neural network. The neural processor 1100 may receive various types of input data from the RAM 1300 or the storage device 1400. On the basis of the received input data, the neural processor 1100 may perform a variety of learning or may infer various data. In an embodiment, the neural processor 1100 may be configured to drive the neural network NN described with reference to FIGS. 1 to 6 or may include the electronic device 100 described with reference to FIGS. 1 to 6. Alternatively, the neural processor 1100 may include the plurality of electronic devices 100 described with reference to FIGS. 1 to 6, and each of the electronic devices included in the neural processor 1100 may exchange signals based on the operations described with reference to FIGS. 1 to 6.

The processor 1200 may perform various calculations necessary for the operation of the electronic device 1000. For example, the processor 1200 may execute firmware, software, or program codes loaded into the RAM 1300. The processor 1200 may control the electronic device 1000 by executing firmware, software, or program codes loaded onto the RAM 1300. The processor 1200 may store the executed results in the RAM 1300 or the storage device 1400.

The RAM 1300 may store data to be processed by the neural processor 1100 or the processor 1200, various program codes or instructions, which are capable of being executed by the neural processor 1100 or the processor 1200, or data processed by the neural processor 1100 or the processor 1200. The RAM 1300 may include a static random access memory (SRAM) or a dynamic random access memory (DRAM).

The storage device 1400 may store data or information required for the neural processor 1100 or the processor 1200 to perform an operation. The storage device 1400 may store data processed by the neural processor 1100 or the processor 1200. The storage device 1400 may store software, firmware, program codes, or instructions that are executable by the neural processor 1100 or the processor 1200. The storage device 1400 may be a volatile memory such as DRAM or SRAM or a nonvolatile memory such as a flash memory.

As described above, the neural network performs learning and inference based on a spike signal. However, to imitate a high level of human intelligence, a plurality of neurons are required. Accordingly, a neural network may be expanded through an external interface, thereby improving the performance of artificial intelligence based on the neural network. As an example, a neural network may be expanded by using an AER interface. The power consumption is small because the AER interface processes a spike signal based on an event. Moreover, because the AER interface serializes and transmits the spike signal, hardware resources are minimally used. However, the AER interface serializes and outputs spike signals that occur in parallel on the neural network, and thus information about the time or order of occurrence of spike signals may be distorted.

According to an embodiment of the present disclosure, an electronic device configured to support a high-speed interface for expanding a neural network may be configured to maximize a speed at which a signal is transmitted to the outside while minimizing distortion of an occurrence time of a spike signal or an occurrence order of spike signals occurring in a plurality of neurons. According to an embodiment of the present disclosure, an arbiter tree included in the electronic device may minimize signal transmission delay through a separate latch and may maintain information about the order of spike signals by having a number of tokens indicating the order of occurrence of spike signals. Accordingly, the arbiter tree may have a number of signal transmission paths for transmitting and receiving signals to the outside, thereby improving the signal transmission speed.

The above description refers to embodiments for implementing the present disclosure. Embodiments in which a design is changed simply or which are easily changed may be included in the present disclosure as well as an embodiment described above. In addition, technologies that are easily changed and implemented by using the above embodiments may be included in the present disclosure. Accordingly, it will be apparent to those of ordinary skill in the art that various changes and modifications may be made to the above embodiments without departing from the spirit and scope of the present disclosure as set forth in the following claims

According to an embodiment of the present disclosure, it is possible to provide an electronic device configured to support a high-speed interface for expanding a neural network expansion with improved reliability and improved performance.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An electronic device configured to support a neural network, the electronic device comprising:
a neuron array including a plurality of neurons;
a row address encoder configured to receive a plurality of spike signals from the plurality of neurons and to output a plurality of request signals in response to the received plurality of spike signals; and
a row arbiter tree configured to receive the plurality of request signals from the row address encoder and to output a plurality of response signals in response to the received plurality of request signals,
wherein the row arbiter tree includes:
a first arbiter configured to arbitrate a first request signal and a second request signal among the plurality of request signals;
a first latch circuit configured to store a state of the first arbiter;
a second arbiter configured to arbitrate a third request signal and a fourth request signal among the plurality of request signals;
a second latch circuit configured to store a state of the second arbiter; and
a third arbiter configured to deliver a response signal to the first arbiter and the second arbiter based on information stored in the first latch circuit and the second latch circuit.

2. The electronic device of claim 1, wherein the row address encoder is configured to:
generate the first request signal in response to a spike signal, which is received from neurons located in a first row among the plurality of neurons, from among the plurality of spike signals;
generate the second request signal in response to a spike signal, which is received from neurons located in a second row among the plurality of neurons, from among the plurality of spike signals;
generate the third request signal in response to a spike signal, which is received from neurons located in a third row among the plurality of neurons, from among the plurality of spike signals; and
generate the fourth request signal in response to a spike signal, which is received from neurons located in a fourth row among the plurality of neurons, from among the plurality of spike signals.

3. The electronic device of claim 1, wherein the row address encoder is configured to:
output a row signal indicating information about a row of neurons, which correspond to the plurality of response signals, from among the plurality of neurons in response to the plurality of response signals.

4. The electronic device of claim 1, wherein the first arbiter is further configured to:
receive the first request signal among the first request signal and the second request signal; and
receive one of the first request signal and the second request signal before outputting a first response signal to the first request signal among the plurality of response signals, and
wherein the second arbiter is further configured to:
receive the third request signal among the third request signal and the fourth request signal; and
receive one of the third request signal and the fourth request signal before outputting a third response signal corresponding to the third request signal among the plurality of response signals.

5. The electronic circuit of claim 4, further comprising:
a third latch circuit configured to store a state of the third arbiter.

6. The electronic device of claim 1, wherein the row address encoder is further configured to:
sequentially output the plurality of spike signals received from the plurality of neurons as a row signal in response to the plurality of response signals.

7. The electronic device of claim 1, further comprising:
a column address encoder configured to receive the plurality of spike signals from the plurality of neurons and to output a plurality of request signals in response to the received plurality of spike signals; and
a column arbiter tree configured to receive the plurality of request signals from the column address encoder and to output a plurality of response signals in response to the received plurality of request signals from the column address encoder.

8. The electronic device of claim 7, wherein the column address encoder is configured to:
output a column signal indicating information about neurons, which correspond to the plurality of response signals, from among the plurality of neurons in response to the plurality of response signals received from the column arbiter tree.

9. An electronic device configured to support a neural network, the electronic device comprising:
a neuron array including a plurality of neurons; and
an interface circuit configured to transmit a plurality of spike signals generated from the plurality of neurons to an external device in parallel,
wherein the interface circuit includes:
a row arbiter tree configured to arbitrate a plurality of request signals corresponding to the plurality of spike signals, and
wherein the row arbiter tree includes:
a first arbiter configured to return a first token in response to a first request signal and a second request signal among the plurality of request signals; and
a second arbiter configured to return a second token in response to a third request signal and a fourth request signal among the plurality of request signals,
wherein a spike signal corresponding to a request signal obtained by returning the first token among the first request signal and the second request signal is transmitted to the external device through a first path, and
wherein a spike signal corresponding to a request signal obtained by returning the second token among the third request signal and the fourth request signal is transmitted to the external device through a second path implemented in parallel with the first path.

10. The electronic device of claim 9, wherein the interface circuit further includes:
a row address encoder configured to:
transmit the plurality of spike signals to the external device in parallel through the first path and the second path based on arbitration of the row arbiter tree.

11. The electronic device of claim 10, wherein the row arbiter tree includes:
a first latch circuit configured to store a state of the first arbiter; and
a second latch circuit configured to store a state of the second arbiter.

12. The electronic device of claim 11, wherein the row address encoder further configured to:
identify a return order of the first token and the second token based on information stored in the first latch circuit and the second latch circuit.
